(19) United States
(12) Patent Application Publication
(10) Pub. No.: US 2024/0228792 A1
(43) Pub. Date: Jul. 11, 2024

(54) BLACK VARNISH AND FILM CONTAINING SAME

(71) Applicant: PI ADVANCED MATERIALS CO., LTD., Gyeongsangnam-do (KR)

(72) Inventors: Gyeong Hyeon RO, Gyeongsangnam-do (KR); Ik Sang LEE, Gyeongsangnam-do (KR)

(21) Appl. No.: 18/561,280

(22) PCT Filed: May 17, 2022
(86) PCT No.: PCT/KR2022/007052

§ 371 Date: Nov. 15, 2023

(30) Foreign Application Priority Data
May 17, 2021 (KR) 10-2021-0063508
May 17, 2022 (KR) 10-2022-0060178

(51) Int. Cl. C09D 5/02; C09D 7/40; C09D 7/48

(52) U.S. Cl. CPC C09D 5/028; C09D 7/48; C09D 7/66

(57) ABSTRACT

The present application provides; a varnish, which is a polyimide precursor that is imidized by thermal curing, and implements the insulation, adhesion, heat resistance, mechanical strength, and light resistance of polyimide; a film including same; and a vehicle device coated with the film.

### TECHNICAL FIELD

The present application relates to a black varnish, a film including the same, and an automotive device coated with the film.

### BACKGROUND ART

With the development of automotive cameras in recent years, various coating materials are researched and developed to prevent cameras from becoming blurry and improve their durability. These coating materials are required to have high insulation, adhesion, heat resistance, light resistance, and mechanical strength.

Resins that can be used for a coating material include a polyimide resin, a polyamide-imide resin, a polyesterimide resin, and the like.

In particular, polyimide resins are suitable for a coating material due to having excellent heat resistance and insulation.

The polyimide resin is a highly heat-resistant resin prepared by solution polymerization of an aromatic dianhydride with an aromatic diamine or an aromatic diisocyanate to prepare a polyamic acid derivative and then imidizing the polyamic acid derivative by ring-closing dehydration at a high temperature.

As a coating method using the polyimide resin, for example, a method of coating an object with a polyimide varnish, which is a precursor of the polyimide resin, and then imidizing the polyimide varnish in a curing oven suitable for heat treatment at a predetermined temperature may be used.

Meanwhile, in the case of devices such as an automotive camera which are affected by a glare or refraction, coating materials for such devices are necessarily required to have durability against light, that is, excellent light resistance.

However, due to lack of light resistance, the polyimide resin has limitations when used for devices required to have light resistance such as an automotive camera.

### Technical Problem

The present application is directed to providing a black varnish, which is a polyimide precursor undergoing imidization during thermal curing and implements insulation, adhesion, heat resistance, mechanical strength, and light resistance of polyimide.

### Technical Solution

In terms of physical properties mentioned herein, when a temperature at the time of measurement affects physical properties, unless otherwise specified, the physical properties are those measured at room temperature.

The term “room temperature” used herein refers to a temperature in an unheated and uncooled state, which may be any temperature in a range of about 10° C. to 30° C. such as a temperature of about 15° C. or higher, 18° C. or higher, 20° C. or higher, or about 23° C. or higher, but about 27° C. or lower. In addition, unless otherwise specified, the unit of temperature mentioned herein is degrees Celsius.

In terms of physical properties mentioned herein, when a pressure at the time of measurement affects physical properties, unless otherwise specified, the physical properties are those measured at normal pressure.

The term “normal pressure” used herein refers to a pressure in a state where the pressure is not increased and decreased, which is generally about 1 atm, that is, standard atmospheric pressure.

In terms of physical properties mentioned herein, when a humidity at the time of measurement affects physical properties, unless otherwise specified, the physical properties are those measured at room temperature, normal pressure, and natural atmospheric humidity.

One aspect of the present application provides a black varnish. For example, the black varnish is a polyimide precursor undergoing imidization during thermal curing and may be used for a coating material for an automotive camera because the black varnish has the insulation, adhesion, heat resistance, mechanical strength, and light resistance of polyimide.

A black varnish according to an embodiment of the present application includes a polyamic acid solution, a polyimide powder, and a black solution, wherein after curing, a breakdown voltage (hereinafter referred to as BDV) is in a range of 1 to 5 KV, and a 60° gloss (GU)(60°) is in a range of 1 to 60. For example, a lower limit of the BDV may be 1.5 KV or more, 2 KV or more, 2.5 kV or more, 3 KV or more, 3.5 kV or more, or 4.0 KV or more, and a lower limit may be 4.9 kV or less, 4.7 KV or less, or 4.5 kV or less. In addition, an upper limit of the GU (60°) may be 59 or less, 58 or less, 55 or less, 52 or less, 50 or less, 48 or less, 45 or less, 40 or less, 35 or less, 30 or less, or 28 or less. A lower limit of the GU (60°) may be, for example, 5 or more, 10 or more, 15 or more, 20 or more, or 25 or more.

Since the black varnish includes a polyamic acid solution, a polyimide powder, and a black solution, the black varnish may provide a polyimide, which simultaneously satisfies light resistance, heat resistance, insulation, adhesion, and mechanical properties at high temperature, after curing. In addition, the black varnish of the present application may form microbubbles through a method such as flux when cured or coated, and during the process, dielectric properties may be reduced so that the black varnish may be used in low dielectric enamels. In particular, since the black varnish of the present application has a black-based color, the black varnish has excellent light resistance by not affecting a glare or refraction, when applied to products.

The BDV may be measured by a method known in the art. In one example, a method of measuring the BDV is as follows. A film specimen of the black varnish is prepared, and all moisture is removed from the film in an oven at 100° C. or below. Then, the specimen is cut into an appropriate size, and a dielectric breakdown tester (PHENIX TECHNOLOGIES 6CCE50-5 according to the Automated Test Set for Insulating Materials, ASTM D149) is used. The specimen is placed on a specimen holder, and voltage is increased from 0 at a constant rate to measure a dielectric strength of an insulator.

The GU (60°) of the specimen may be measured using a gloss meter (PG-II or PG-IIM commercially available from NIPPON DENSHOKU) according to ASTM D523.

In one example, the polyamic acid solution may include one or more dianhydride monomers and one or more diamine monomers as polymerization units.

For example, a dianhydride monomer that can be used to prepare the polyamic acid solution may be an aromatic tetracarboxylic dianhydride, and the aromatic tetracarboxylic dianhydride may be pyromellitic dianhydride (PMDA), 3,3′,4,4′-biphenyltetracarboxylic dianhydride (BPDA), 2,3,3′,4′-biphenyltetracarboxylic dianhydride (a-BPDA), oxydiphthalic dianhydride (ODPA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenone tetracarboxylic dianhydride (BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, or 4,4′-(2,2-hexafluoroisopropylidene)diphthalic acid dianhydride.

The dianhydride monomer may be used alone or in a combination of two or more as needed and include, for example, pyromellitic dianhydride (PMDA), 3,3′,4,4′-biphenyltetracarboxylic dianhydride (s-BPDA), or 2,3,3′,4′-biphenyltetracarboxylic dianhydride (a-BPDA).

A diamine monomer that can be used to prepare the polyamic acid solution is an aromatic diamine. Examples of the aromatic diamine may be classified as follows:
1) a diamine having one benzene nucleus in a structure, which is a relatively rigid structure, such as 1,4-diaminobenzene (p-phenylenediamine, PDA), 1,3-diaminobenzene, 2,4-diaminotoluene, 2,6-diaminotoluene, or 3,5-diaminobenzoic acid (DABA);
2) a diamine having two benzene nuclei in a structure such as 4,4′-diaminodiphenylmethane (methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine (o-tolidine), 2,2′-dimethylbenzidine (m-tolidine), 3,3′-dimethoxybenzidine, 2,2′-dimethoxybenzidine, 3,3′-diaminodiphenyl ether, 3,4′-diaminodiphenyl ether, 4,4′-diaminodiphenyl ether (oxydianiline, ODA), 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, or 4,4′-diaminodiphenyl sulfoxide;
3) a diamine having three benzene nuclei in a structure such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene (TPE-Q), 1,4-bis(4-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenyl sulfide)benzene, 1,3-bis(4-aminophenyl 1,4-bis(4-aminophenyl sulfide)benzene, 1,3-bis(3-aminophenyl sulfone)benzene, 1,3-bis(4-aminophenyl sulfone)benzene, 1,4-bis(4-aminophenyl sulfone)benzene, 1,3-bis[2-(4-aminophenyl)isopropyl]benzene, 1,4-bis[2-(3-aminophenyl)isopropyl]benzene, or 1,4-bis[2-(4-aminophenyl)isopropyl]benzene;
4) a diamine having four benzene nuclei in a structure such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, or 2,2-bis[4-(4-aminophenoxy)phenyl]-1,1,1,3,3,3-hexafluoropropane.

The diamine monomer may be used alone or in a combination of two or more as needed, and considering bond dissociation energy, and in the present application, the diamine monomer may include, for example. 4,4′-diaminodiphenyl ether (oxydianiline, ODA), 1,4-diaminobenzene (PPD), 1,3-diaminobenzene (MPD), 2,4-diaminotoluene, 2,6-diaminotoluene, or 4,4′-methylenediamine (MDA).

In one specific example, the black varnish may include 5 to 40 wt %, 10 to 30 wt %, 15 to 20 wt % of a solid content based on a total weight. In the present application, by adjusting the solid content of the black varnish, it is possible to prevent increases in manufacturing costs and processing time due to the need to remove a large amount of solvent in a curing process while controlling an increase in viscosity.

In one specific example, a weight-average molecular weight of the polyamic acid of the present application may be in a range of 10,000 to 100,000 g/mol, 15,000 to 80,000 g/mol, 18,000 to 70,000 g/mol, 20,000 to 60,000 g/mol, 25,000 to 55,000 g/mol, or 30,000 to 50,000 g/mol. The term “weight-average molecular weight” used herein refers to a converted value with respect to standard polystyrene, as measured by gel permeation chromatography (GPC).

The polyamic acid solution of the present application may include an organic solvent. The organic solvent may be, but is not limited to, any organic solvent in which polyamic acid is soluble, and an aprotic polar solvent may be an example.

The aprotic polar solvent may include, for example, amide-based solvents including N,N′-dimethylformamide (DMF), N,N′-diethylformamide (DEF), N,N′-dimethylacetamide (DMAc), and dimethylpropanamide (DMPA), phenol-based solvents including p-chlorophenol and o-chlorophenol, and N-methyl-pyrrolidone (NMP), gamma-butyrolactone (GBL), and diglyme, which may be used alone or in a combination of two or more.

In the present application, in some cases, the solubility of the polyamic acid may be adjusted using an auxiliary solvent such as toluene, tetrahydrofuran, acetone, methylethylketone, methanol, ethanol, or water.

For example, the organic solvent may be N,N′-dimethylacetamide (DMAc) or N-methyl-pyrrolidone (NMP).

The polyimide powder is a polyimide in a solid state, and since the polyimide powder is dispersed rather than dissolved in the solution after curing, the varnish may exhibit a matte property. Generally, it is difficult to get BDV values of a varnish in which conductive materials such as carbon black are added, but when the polyimide powder is added, the varnish exhibits a matte property so that BDV values are obtained. Meanwhile, the polyimide powder in a solid state may not significantly affect the physical properties of the varnish even when an amount of the polyimide powder is increased or decreased.

The GU (60°) may be adjusted within the above-mentioned range through a change in composition and amount of the black solution. The GU (60°) is an indicator of gloss, which may be measured by a method using a gloss meter and known in the art.

In one specific example, the black solution may include a black pigment and a solvent. Any black pigment that is black may be used as the black pigment without particular limitation, and any inorganic or organic pigment may be used without limitation.

For example, the inorganic pigment may be carbon black, triferrous tetraoxide, titanium black oxide, copper manganese black, copper chrome black, or cobalt black, which may be used alone or in a combination of two or more.

The organic pigment may be cyanine black, aniline black, a phthalocyanine derivative, a porphyrin derivative, or a triphenylamine derivative, which may be used alone or in a combination of two or more.

The black pigment includes a black mixture of red, blue, green, yellow, and other pigments. In addition, as long as the advantageous effects of the present invention are not affected, the black pigment may be used in combination with other pigments or colorants such as a dye.

The solvent may be an organic solvent. Any organic solvent in which the black pigment is soluble may be used as the organic solvent without particular limitation, and an aprotic polar solvent may be an example.

The aprotic polar solvent may include amide-based solvents including N,N′-dimethylformamide (DMF), N,N′-diethylformamide (DEF), N,N′-dimethylacetamide (DMAc), and dimethylpropanamide (DMPA), phenol-based solvents including p-chlorophenol and o-chlorophenol, N-methyl-pyrrolidone (NMP), gamma butyrolactone (GBL), and diglyme, which may be used alone or in a combination of two or more.

The black solution may further include at least one of a dispersant, a stabilizer, and a release agent. Any dispersant, stabilizer, and release agent may be used as long as the dispersant, stabilizer, and release agent are compatible with the black pigment. For example, various surfactants known in the art may be used as the dispersant, various paints, inks, and adhesive resins known in the art may be used as the stabilizer, and various leveling agents and polyether-based siloxane composite known in the art may be used as the release agent.

In one example, an amount of the black pigment of the present application may be in a range of 1 to 20 wt % based on a total solid content, such as 1 to 15 wt % or 1 to 10 wt %. In another example, an amount of the black pigment may be 0.01 to 0.1 or 0.05 to 0.1 parts by weight based on 100 parts by weight of polyamic acid. In the present application, excellent light resistance and electrical properties of the varnish may be achieved by adjusting the amount of the black pigment within the range described above.

In still another example, the black solution may further include 0.1 to 1 part by weight, 0.1 to 0.8, 0.1 to 0.6, 0.1 to 0.5, 0.2 to 1, 0.3 to 0.8, or 0.4 to 0.6 parts by weight of the dispersant based on 100 parts by weight of the black pigment. In addition, the black solution may further include 0.1 to 1.5, 0.2 to 1.4, 0.3 to 1.3, 0.4 to 1.2, or 0.5 to 1.0 parts by weight of the stabilizer based on a total solid content. Each amount of the dispersant and stabilizer of the present application may be appropriately selected within the range described above depending on desired viscosity and dispersibility.

In the present application, in order to obtain desired dispersibility and the desired uniform surface (roughness) of a film, a particle size ratio of the black pigment and the polyimide powder and each particle size may be adjusted within the range described below.

In one example, the particle size ratio of the black pigment and polyimide powder of the present application may be in a range of 1:0.5 to 1:3, 1:0.5 to 1:2.5, 1:0.5 to 1:2, 1:0.5 to 1:1.5, 1:0.7 to 1:3, 1:0.7 to 1:2.5, 1:0.7 to 1:2, 1:0.7 to 1:1.5, 1:1 to 1:3, 1:1 to 1:2.5, or 1:1 to 1:2. In another example, an average particle size (D50) of the black pigment may be in a range of 1 to 30 μm, 1 to 25 μm, 1 to 20 μm, 1 to 15 μm, or 1 to 10 μm. In addition, an average particle size (D50) of the polyimide powder may be 1 to 30 μm, 1 to 25 μm, or 1 to 20 μm. The average particle size (D50) is the value of the particle size having a cumulative volume percentage of 50% in the cumulative volume distribution.

In the present application, an amount of polyamic acid may be in a range of 5 to 30 wt %, 5 to 25 wt %, 5 to 20 wt %, 10 to 20 wt %, or 15 to 20 wt % based on a total solid content.

In still another example, an amount of polyimide powder may be 1 to 30 parts by weight, 1 to 25 parts by weight, 1 to 20 parts by weight, 5 to 25 parts by weight, or 5 to 20 parts by weight based on 100 parts by weight of polyamic acid. An example of a monomer composing the polyimide may be the same as that of the monomer contained in the polyamic acid described above. The polyimide powder may include a diamine monomer and a dianhydride monomer, and examples are the same as those described above.

The black varnish of the present application may have low viscosity. The black varnish of the present application may have a viscosity of 50,000 cP, 40,000 cP, 30,000 cP, 20,000 cP, 10,000 cP or less, or 9,000 cP or less when measured at a temperature of 30° C. and a shear rate of 1 s⁻¹. A lower limit is not particularly limited but may be 500 cP or more or 1000 cP or more. The viscosity may be measured, for example, using Rheostress 600 commercially available from Haake and may be measured at a shear rate of 1 s⁻¹, a temperature of 33° C., and a plate gap of 1 mm. The varnish may have excellent processability and be easily applied to products by adjusting viscosity within the above range.

Another aspect of the present application provides a film including a cured product of the black varnish described above. The film may be applied in coating of an automotive device.

The film may be thin so as to coat products sufficiently, and a thickness of the film may be, for example, in a range of 1 to 100 μm, 5 to 90 μm, 5 to 80 μm, 5 to 70 μm, 10 to 100 μm, 10 to 90 μm, 10 to 80 μm, 10 to 70 μm, 10 to 60 μm, 10 to 50 μm, 20 to 100 μm, 20 to 90 μm, 20 to 80 μm, 20 to 70 μm, 20 to 60 μm, or 20 to 50 μm.

Furthermore, by changing the above-described components of the black varnish and the amount thereof, the film may allow various physical properties to be adjusted in the range described below.

An elongation of the coating film measured using a universal testing machine (UTM) may be in a range of 10% to 60%. For example, the elongation may be 55% or less, 50% or less, 45% or less, 40% or less, 35% or less, 30% or less, 25% or less, or 20% or less, and an upper limit of the elongation may be 11% or more, 12% or more, 13% or more, 14% or more, or 15% or more. A tensile strength of the coating film measured using a UTM may be 150 Mpa or less, 145 Mpa or less, 140 Mpa or less, 135 Mpa or less, or 130 Mpa or less. A modulus of the coating film measured using a UTM may be 10 Gpa or less, 9 Gpa or less, 8 Gpa or less, 7 Gpa or less, 6 Gpa or less, 5 Gpa or less, 4 Gpa or less, or 3 Gpa or less. The elongation, tensile strength, and modulus may be measured using a UTM at a width of 20 mm, a grip distance of 50 mm, and a crosshead speed of 20 min/min.

A coefficient of thermal expansion (CTE) of the film measured using a thermo mechanical analysis (TMA) device may be in a range of 5 ppm/° C. to 50 ppm/° C., 10 ppm/° C. to 45 ppm/° C., 15 ppm/° C. to 40 ppm/° C., 20 ppm/° C. to 40 ppm/° C., 25 ppm/° C. to 40 ppm/° C., or 25 ppm/° C. to 35 ppm/° C. The coefficient of thermal expansion may be measured using a TMA device with a load of 0.02 N at a temperature increase rate of 10° C./min in a temperature range of 50 to 200° C.

A glass transition temperature of the film measured using a dynamic mechanical analysis (DMA) device may be 200 to 500° C., 250 to 450° C., 300 to 400° C., or 350 to 400° C. The glass transition temperature may be measured using a DMA device at a temperature increase rate of 5° C./min.

A 1% thermal decomposition temperature (td) of the film measured using a thermogravimetric analysis (TGA) device may be in a range of 300 to 500° C., 350 to 500° C., 400 to 500° C., or 450 to 500° C., and a 5% thermal decomposition temperature of the film may be in a range of 450 to 600° C., 450 to 550° C., or 450 to 500° C. The thermal decomposition temperature may be measured by preheating to 150° C. and using the TGA device at a temperature increase rate of 10° C./min for 30 minutes.

A dielectric constant (Dk) of the film according to ASTM D150 may be in a range of 1 to 5, 1 to 4.5, 1.5 to 4.5, 2 to 4, 2.5 to 4, 3 to 4, or 3.5 to 4, and a dielectric loss factor (Df) of the film may be in a range of 0.0001 to 0.1, 0.001 to 0.1, 0.005 to 0.1, 0.01 to 0.1, or 0.015 to 0.1.

Still another aspect of the present application provides an automotive device coated with the film described above. The device may be, but is not limited to, an automotive camera whose surface is coated with the above-described film and other various devices such as an automotive sensor and a lens module. Since the automotive device is coated with the above-described film, the automotive device may have excellent heat resistance, light resistance, and electrical properties.

### Advantageous Effects

The present application provides a black varnish that has a low dielectric constant and simultaneously realizes mechanical properties such as light resistance, heat resistance, insulation, and the like under harsh conditions such as high temperature, a film including the same, and an automotive device coated with the film.

### Modes of the Invention

Hereinafter, examples of the present application will be described in detail, but the present application is not limited to the examples described below.

### EXAMPLE 1

### Preparation of Polyamic Acid Solution

Polyamic acid was prepared by polymerizing 100 parts by weight of oxydianiline (ODA) and 100 parts by weight of pyromellitic dianhydride (PMDA). A polyamic acid solution was prepared by mixing 20 parts by weight of the polyamic acid and 80 parts by weight of N,N′-dimethylacetamide (DMAc), and the solid content of the polyamic acid solution was 15 wt % based on a total amount of the solution.

### Preparation of Black Solution

A black solution was prepared by mixing 18 parts by weight of carbon black (Austin Black, D50: 3 μm) and 83 parts by weight of N,N′-dimethylacetamide (DMAc).

During the mixing, 0.075 parts by weight of BYK L9540 was added as a dispersant and 0.075 parts by weight of BYK-333 was added as a stabilizer and release agent.

### Preparation of Black Varnish

A black varnish was prepared by mixing the polyamic acid solution and the black solution with a polyimide powder (D50: 3 μm). The polyimide powder was prepared by preparing polyimide from oxydianiline (ODA) and pyromellitic dianhydride (PMDA) using a known method and then performing solvent substitution, drying, and milling.

The black solution was added so that an amount of carbon black was 5 wt % based on solid content (the same as total solid content), and 10 parts by weight of the polyimide powder based on 100 parts by weight of polyamic acid was added.

An amount of polyamic acid was 15 wt % based on a total solid content in the black varnish.

### Preparation of Film

The black varnish was cured sequentially at 100° C. for 20 minutes, 150° C. for 20 minutes, 200° C. for 20 minutes, 300° C. for 20 minutes, 350° C. for 20 minutes, and 110° C. for 60 minutes to prepare a film with a thickness of 30 μm.

### EXAMPLE 2

A film was prepared in the same manner as in Example 1, except that polyimide was prepared by polymerizing 75 parts by weight of oxidianiline (ODA), 25 parts by weight of 1,4-diaminobenzene (PPD), and 100 parts by weight of pyromellitic dianhydride (PMDA).

### EXAMPLE 3

A film was prepared in the same manner as in Example 1, except that polyimide was prepared by polymerizing 50 parts by weight of oxydianiline (ODA), 50 parts by weight of 1,4-diaminobenzene (PPD), and 100 parts by weight of pyromellitic dianhydride (PMDA).

### EXAMPLE 4

A film was prepared in the same manner as in Example 1, except that polyimide was prepared by polymerizing 100 parts by weight of 1,4-diaminobenzene (PPD) and 100 parts by weight of pyromellitic dianhydride (PMDA).

### COMPARATIVE EXAMPLE 1

A black varnish was prepared in the same manner as in Example 1, except that the black solution was added so that the amount of carbon black was 25 wt % based on a solid content, and 35 parts by weight of the polyimide powder based on 100 parts by weight of polyamic acid was added.

### COMPARATIVE EXAMPLE 2

A black varnish was prepared in the same manner as in Example 1, except that the black solution was added so that the amount of carbon black was 0.5 wt % based on a solid content, and 0.5 parts by weight of the polyimide powder based on 100 parts by weight of polyamic acid was added.

### 1. Measurement of Gloss

A 60° gloss of a film prepared in each of the examples was measured according to ASTM D523 using a gloss meter (PG-II or PG-IIM commercially available from NIPPON DENSHOKU).

### 2. Measurement of BDV Values

A film-type specimen of black varnish prepared in each of the examples was prepared, and all moisture was removed from the films in an oven at 100° C. or below. Then, each specimen was cut into an appropriate size, and a dielectric breakdown tester (PHENIX TECHNOLOGIES 6CCE50-5 according to the Automated Test Set for Insulating Materials, ASTM D149) was used. Each specimen was placed on a specimen holder, and voltage was increased from 0 at a constant rate to measure a dielectric strength of an insulator.

### 3. Measurement of Elongation, Tensile Strength, and Modulus

An elongation, tensile strength, and modulus of a film prepared in each of the examples were measured using a UTM at a width of 20 mm, a grip distance of 50 mm, and a crosshead speed of 20 min/min.

### 4. Measurement of Glass Transition Temperature (Tg)

A glass transition temperature of a film prepared in each of the examples was measured using a DMA device at a temperature increase rate of 5° C./min.

The results of the above measurements are shown in Table 1 below.

TABLE 1

| | | | | Tensile | Mod- | |
|---|---|---|---|---|---|---|
| | GU | BDV | Elon- | strength | ulus | |
| | (60°) | (kV) | gation | (MPa) | (GPa) | Tg |
| Example 1 | 26 | 4.2 | <30% | <130 | <3.2 | <400° C. |
| Example 2 | 52 | 3.9 | <30% | <130 | <3.2 | <400° C. |
| Example 3 | 35 | 3.4 | <20% | <130 | <3.2 | <400° C. |
| Example 4 | 48 | 3.7 | <20% | <130 | <3.2 | <400° C. |
| Comparative | Less | Less | <10% | >150 | N.A. | N.A. |
| Example 1 | than 1 | than 1 | | | | |
| Comparative | More | More | >60% | >150 | N.A. | N.A. |
| Example 2 | than 60 | than 5 | | | | |
| Example 1 | 26 | 4.2 | <30% | <130 | <3.2 | <400° C. |
| Example 2 | 52 | 3.9 | <30% | <130 | <3.2 | <400° C. |
| Example 3 | 35 | 3.4 | <20% | <130 | <3.2 | <400° C. |
| Example 4 | 48 | 3.7 | <20% | <130 | <3.2 | <400° C. |
| Comparative | Less | Less | <10% | >150 | N.A. | N.A. |
| Example 1 | than 1 | than 1 | | | | |
| Comparative | More | More | >60% | >150 | N.A. | N.A. |
| Example 2 | than 60 | than 5 | | | | |

1. A black varnish comprising:
a polyamic acid solution;
a polyimide powder; and
a black solution,
wherein after curing, a breakdown voltage (BDV) is in a range of 1 to 5 kV, and a 60° gloss (GU 60°) is in a range of 1 to 60.

2. The black varnish of claim 1, wherein the black solution includes a black pigment and a solvent.

3. The black varnish of claim 2, wherein an amount of the black pigment is in a range of 1 to 20 wt % based on a total solid content.

4. The black varnish of claim 2, wherein the black pigment is included in a range of 0.01 to 0.1 parts by weight based on 100 parts by weight of polyamic acid.

5. The black varnish of claim 2, wherein the black solution further includes 0.1 to 1 part by weight of a dispersant based on 100 parts by weight of the black pigment.

6. The black varnish of claim 2, wherein the black solution further includes 0.1 to 1.5 parts by weight of a stabilizer based on 100 parts by weight of the black pigment.

7. The black varnish of claim 2, wherein a particle size ratio of the black pigment and the polyimide powder is in a range of 1:0.5 to 1:3.

8. The black varnish of claim 1, wherein an amount of polyamic acid is in a range of 5 to 30 wt % based on a total solid content.

9. The black varnish of claim 1, wherein an amount of the polyimide powder is 1 to 30 parts by weight based on 100 parts by weight of polyamic acid.

10. The black varnish of claim 1, wherein a viscosity measured at a temperature of 30° C. and a shear rate of 1 s⁻¹ is in a range of 1,000 to 50,000 cP.

11. A film comprising a cured product of the black varnish according to claim 1.

12. The film of claim 11, wherein a thickness of the film is in a range of 1 to 100 μm.

13. The film of claim 11, wherein an elongation is in a range of 10% to 60%, a tensile strength is 150 Mpa or less, and a modulus is 10 Gpa or less, according to measurements using a universal testing machine (UTM).

14. The film of claim 11, wherein a coefficient of thermal expansion (CTE) measured using a thermo mechanical analysis (TMA) device is in a range of 5 ppm/° C. to 50 ppm/° C.

15. The film of claim 11, wherein a glass transition temperature measured using a dynamic mechanical analysis (DMA) device is in a range of 200 to 500° C.

16. The film of claim 11, wherein a 1% thermal decomposition temperature (td) is in a range of 300 to 500° C., and a 5% thermal decomposition temperature is in a range of 450 to 600° C., according to measurements using a thermogravimetric analysis (TGA) device.

17. The film of claim 11, wherein a dielectric constant (Dk) measured according to ASTM D150 is in a range of 1 to 5, and a dielectric loss factor (Df) is in a range of 0.0001 to 0.1.

18. An automotive device coated with the film according to claim 11.
